(19) United States
(12) Patent Application Publication
(10) Pub. No.: US 2006/0085162 A1
(43) Pub. Date: Apr. 20, 2006

(54) Laboratory sample transfer apparatus with interchangeable tools

(76) Inventors: Torleif Ove Bjornson, Gilroy, CA (US); Christoph Kaufmann, Wolfhausen (CH); Nikolaus Ingenhoven, Uerikon (CH); Hans-Jorg Grill, Verikon (CH)

Correspondence Address: NOTARO AND MICHALOS, 100 DUTCH HILL ROAD, SUITE 110, ORANGEBURG, NY, 10962-2100, US

(21) Appl. No.: 10/965,936

(22) Filed: Oct. 15, 2004

(51) Int. Cl. G06F 15/00

(52) U.S. Cl. 702/150

(57) ABSTRACT

Apparatuses for and a method of transferring an assay protocol developed with an operator carried, hand held sample transfer tool to a robotic sample processor of a laboratory workstation are disclosed. The method comprises the execution of an assay protocol with a sample transfer apparatus (1), comprising a laboratory working area (2) with a first position retrieval system (3); a hand held sample transfer tool (10) with an active tool piece (5), which is manually carried by an operator (11); and a data processing unit (6) comprising a calculator (7), a memory (8), and a display (9); the data processing unit (6), and the first position retrieval system (3) being in communication connection with each other. The method also comprises detection of the actual position of the active tool piece (5) at every assay protocol step with the first position retrieval system (3) of the laboratory working area (2) in at least one of the X, Y, and Z directions of a 2-D or 3-D coordinate system and storing these data as a position data set. The method in addition comprises detection of all individual protocol parameters at every assay protocol step as a parameter data set and adding this parameter data set to the position data set, thereby creating a position/parameter data set. The method further comprises processing of all position/parameter data sets of the assay protocol as a virtual protocol and storing this virtual assay protocol with the data processing unit (6); and loading of the virtual assay protocol into the data processing unit of the laboratory workstation and attaching the hand held sample transfer tool or its basic components to the robotic sample processor of the laboratory workstation. The virtual assay protocol then can be manually executed at other places or automatically executed with the robotic sample processor of the laboratory workstation.

### RELATED FIELD OF TECHNOLOGY

The present invention relates to a sample transfer apparatus that comprises a laboratory working area with a position retrieval system, a sample transfer tool with an active tool piece, and a data processing unit comprising a calculator, a memory, and a display. The actual position of the active tool piece usually is detectable by the position retrieval system in at least one of the X, Y, and Z directions of a 2-D or 3-D coordinate system as a position data set to be processed, stored, and displayed with the data processing unit. The active tool piece of the sample transfer tool, the data processing unit, and the position retrieval system usually are in communication connection with each other.

### RELATED PRIOR ART

Various industries and laboratories require automated systems for the movement, processing, and inspection of goods on workstations. In pharmaceutical research, clinical diagnostics as well as in forensics, for example, there are several types of automation systems used. Each one of these systems is essentially a variant of a method to handle liquid and/or solid samples and to perform operations on these samples, such as mixing, optical measurements, pipetting, washing, incubation, and

Such automation systems share the characteristic that sample transfer and manipulation operations are carried out by workstations or so-called robotic sample processing (RSP) instruments. Another shared characteristic is that samples are often manipulated on standardized micro-plates, on Petri dishes, in tubes and other sample containers. These plates come in a variety of formats, but typically contain 96 wells in an 8 by 12 grid on 9 mm centers. Plates at even multiples or fractions of densities are also used. Various workstations may be linked together with one or more plate carrying robots. One or more robots, such as Cartesian or polar coordinate based robots can be used for operating on a worktable surface. The robots can carry plates, but they can also perform liquid transfer operations, such as pipetting, which comprises aspiration (uptake) and dispensation (delivery). Usually, aspiration and dispensation are carried out at different locations on the worktable of a workstation. Another liquid handling operation is called dispensation, which just means delivering sample volumes to targets or containers. A central control system or computer controls these RSP instruments. The primary advantage of such an apparatus is complete hands free operation. Accordingly, these instruments can run for hours or days at a time with no human intervention. Another advantage of these instruments is based on their capability to carry out complex liquid handling operations, such as the execution of complete assay protocols which may comprise all possible operations on these samples, such as mixing, optical measurements, pipetting, dispensing, washing, incubation, and filtration. Also manipulations on or with solid-state materials, such as sorting allergen discs may be incorporated into an assay protocol.

In most cases, assay protocols are developed with an operator carried, hand held sample transfer tool, such as a dispenser, a pipette, a pair of tweezers, a loop, or a needle. The transferred samples therefore comprise liquids, allergen discs, bacterial colonies, and gel portions. After establishing a more or less complex assay protocol and after manual testing with hand held sample transfer tools, the assay protocol can be routinely carried out manually by specially trained laboratory personal. However, manual working is traditionally known to be prone to errors and operator fatigue, in particular if hundreds of repeating steps or cycles of procedures are to be applied. As a result, the deposition of samples at wrong locations, contamination problems, or the utilization of wrong volumes or sources of liquids may occur. In many kinds of applications, such errors may have severe consequences. In order to reduce the risk of fatigue or even injury of the operators, ergonomic hand held pipettes have been developed (see for example U.S. 2002/0012613 A1).

In order to reduce the risk of operation errors, intelligent hand held pipettes have been developed comprising:
A calibrated electronic digital volumetric display (see e.g., U.S. Pat. No. 4,567,780);
A system of reading parameters of exchangeable shafts as well as for reading and displaying the set volume (see e.g., WO 2004/052543 A1);
A display and an on site microprocessor for generating (within a pipette mode of operation) liquid pick up volume, liquid dispense and their respective correction factors, pipette speed of operation and pipette reset signals for controlling operation of the pipette and the alphanumeric display (see U.S. Pat. No. 6,254,832 B1). Using a cycle counting feature, the user is continuously advised of the operational cycle of a pipette. This enables the user to interrupt a sequence of pipette operations without losing track of the particular cycle of pipette operation;

A balance in combination with the pipette for the guided production of a particular solution of a substance in a solvent (see EP 1 452 849 A1). There an intelligent hand held pipette as known from U.S. Pat. No. 6,299,841 B1 or from U.S. Pat. No. 6,778,917 B1 may be utilized. The pipette and the balance comprise a memory and an interface for exchange data. The balance additionally may be connected to a personal computer and a process protocol may be printed.

Another approach for the enhanced security of manually working with assay protocols includes a well indicating device for identifying (e.g., in a predetermined but variable sequence) wells of a plurality of independent but interrelated substance receiving wells of a microtiter tray (see U.S. Pat. No. 4,701,754).

All these approaches suffer from the fact that the transfer operation, i.e., the pipetting process physically has to be carried out (and is thus, limited in speed and precision) by a human operator.

As robotic sample processors are well known and widely accepted, an established assay protocol very often is therefore transferred to an automated laboratory workstation. However, transferring an assay protocol from manual to automation requires defining and verifying important procedure parameters, such as liquid classes and volumes. Such transfers of assay protocols most of the time turn out to be difficult and time consuming, because e.g., hand held pipettes use different tips and pipetting regimes as well as different liquid handling technologies than automated work stations.

### OBJECTS AND SUMMARY OF THE INVENTION

An object of the present invention is to provide a method and an apparatus that eliminate the dependence of manual sample transfers, like pipetting, on the attention and concentration of a human operator.
Another object of the present invention is to provide a method and an apparatus for monitoring manual sample transfer operations and providing data monitoring for process compliance.
Another object of the present invention is to suggest alternative instruments and methods for transferring an assay protocol from manual to automated execution.
An additional object of the present invention is to provide an apparatus that provides for a data set, which is required for transferring an assay protocol from manual to, automated execution.
A further object of the present invention is to provide an apparatus that is able to easily utilize the data set, which is required for transferring an assay protocol from manual to, automated execution.

These and even further objects are achieved with the features of the independent claims attached. Advantageous refinements and additional features of the present invention result from the dependent claims.

Provided that:
A laboratory workstation with robotic sample processor is accessible now or later;
The laboratory workstation also comprises a worktable, a data processing unit with a calculator, a memory, and a display;
The laboratory workstation further comprises a position retrieval system that is implemented as drives for X, Y, and Z movements of the robotic sample processor;
The second position retrieval system is in communication connection with the data processing unit and the position retrieval system;
   the method of transferring an assay protocol developed with an operator carried, hand held sample transfer tool to a robotic sample processor of a laboratory workstation, according to the present invention, is based on the following concept:

An assay protocol is executed with a sample transfer apparatus, comprising a laboratory working area with a first position retrieval system. The transfer apparatus also comprises a hand held sample transfer tool with an active tool piece, which is manually carried by an operator and a data processing unit comprising a calculator, a memory, and a display. The data processing unit and the first position retrieval system preferably are in communication connection with each other. During this manual execution of the assay protocol, the actual position of the active tool piece at every assay protocol step is detected with the first position retrieval system in at least one of the X, Y, and Z directions of a 2-D or 3-D coordinate system and these data are stored as a position data set. At every assay protocol step, all individual protocol parameters are additionally detected as a parameter data set and this parameter data set is then added to the position data set, thereby a number of position/parameter data sets are created. All position/parameter data sets then are processed with the data processing unit and the assay protocol is stored as a virtual assay protocol. The virtual assay protocol is loaded into the data processing unit of a laboratory workstation and the hand held sample transfer tool is attached to the robotic sample processor of the laboratory workstation. This attachment of the hand held sample transfer tool to the robotic sample processor of the laboratory workstation may be executed by clipping the transfer tool to a Z-axis rod of the robotic sample processor or by equipping the robotic sample processor with the basic function elements of the transfer tool. In case of a pipette, the basic function elements comprise a bidirectional pump system.

An apparatus that provides for a data set which is required for transferring an assay protocol from manual to automated execution is a sample transfer apparatus, comprising a laboratory working area with a first position retrieval system, a sample transfer tool with an active tool piece, and a data processing unit comprising a calculator, a memory, and a display. The actual position of the active tool piece is detectable by the first position retrieval system in at least one of the X, Y, and Z directions of a 2-D or 3-D coordinate system as a position data set to be processed, stored, and displayed with the data processing unit. The active tool piece of the sample transfer tool, the data processing unit, and the first position retrieval system are in communication connection with each other. The sample transfer apparatus according to a first aspect of the invention is characterized in that the sample transfer tool is a hand held sample transfer tool, which is manually carried by an operator. The active tool piece of the sample transfer tool comprises a reference unit that is designed to interact with the first position retrieval system of the laboratory working area for the generation of a position data set.

An apparatus that is able to easily utilize the data set which is required for transferring an assay protocol from manual to automated execution is a sample transfer apparatus, comprising a laboratory workstation with a worktable, a second position retrieval system, a robotic sample processor with a sample transfer tool and an active tool piece, and a data processing unit comprising a calculator, a memory, and a display. The actual position of the active tool piece is detectable by the second position retrieval system in at least one of the X, Y, and Z directions of a 2-D or 3-D coordinate system as a position data set to be processed, stored, and displayed with the data processing unit. The active tool piece of the sample transfer tool, the data processing unit, and the second position retrieval system are in communication connection with each other. The sample transfer apparatus according to a second aspect of the invention is characterized in that the sample transfer tool is a hand held sample transfer tool, which is attached to the robotic sample processor of the laboratory workstation. The second position retrieval system is implemented as the drives for X, Y, and Z movements of the robotic sample processor for the generation of the position data set.

### ADVANTAGES PROVIDED BY THE INVENTION

Advantages of the present invention comprise:
1. The first inventive embodiment is an apparatus that combines the advantages of a simple to use hand held sample transfer tool and of a first position retrieval system that provides full process control and the production of a virtual assay protocol.
2. The second inventive embodiment is an apparatus that combines the advantages of an automatic sample processor work station, which is provided with the basic elements of the hand held sample transfer tool and the virtual assay protocol.
3. The basic elements of a hand held transfer tool can be integrated into the automatic sample processor workstation by attaching the hand held sample transfer tool to the robotic sample processor.
4. The basic elements of a hand held transfer tool can be integrated into the automatic sample processor workstation by equipping the robotic sample processor with the basic function elements of the hand held sample transfer tool.
5. The hand held sample transfer tool and the robotic sample processor have identical sample transfer tools, thus identical triggering parameters can be utilized to monitor the function of these sample transfer tools.
6. When using pipettes as sample transfer tools, identical tips and pipetting regimes can be utilized.
7. Several manual workplaces can be organized and controlled by a small number of personal computers (PC), e.g., by one PC per laboratory room.
8. The manual sample transfer apparatus according to the first inventive embodiment can be operated in a first laboratory and the automatic sample transfer apparatus according to the second inventive embodiment can be operated in the same and/or in a second, even remote laboratory at any time.
9. Documentation of assay protocols is improved.
10. Quality control and process control is standardized and centralized.
11. The manual work places can be linked to other systems, such as detection devices and thermocyclers.
12. Detailed assay protocols with clear instructions for every single protocol step are generated.
13. Since the controller of the manual work place according to the first inventive embodiment always knows what the operator is doing with the sample transfer tool, with the detailed assay protocol loaded, the controller can guide the operator step by step through a pre-established procedure. This is preferably made by visual or auditory instructions of the controller or computer to the operator, advising him what to do next and how trough each step of the assay protocol.

### BRIEF DESCRIPTION OF THE DRAWINGS

The device according to the present invention and the method according to the present invention will be described in greater detail on the basis of schematic and exemplary drawings, without these drawings restricting the scope of the present invention. It is shown in:

FIG. 1 a three dimensional scheme of a first embodiment of a sample transfer apparatus, of which the sample transfer tool is implemented as a hand held sample transfer tool;

FIG. 2A a partial vertical section through the hand held sample transfer tool of FIG. 1;

FIG. 2B a schematic layout of the basic function elements of the hand held sample transfer tool for the equipment of a robotic sample processor;

FIG. 3 a three dimensional scheme of a second embodiment of a sample transfer apparatus, which is implemented as a work station in that the hand held sample transfer tool of FIG. 2 is attached to the automatic sample processor.

### DETAILED DESCRIPTION OF THE INVENTION

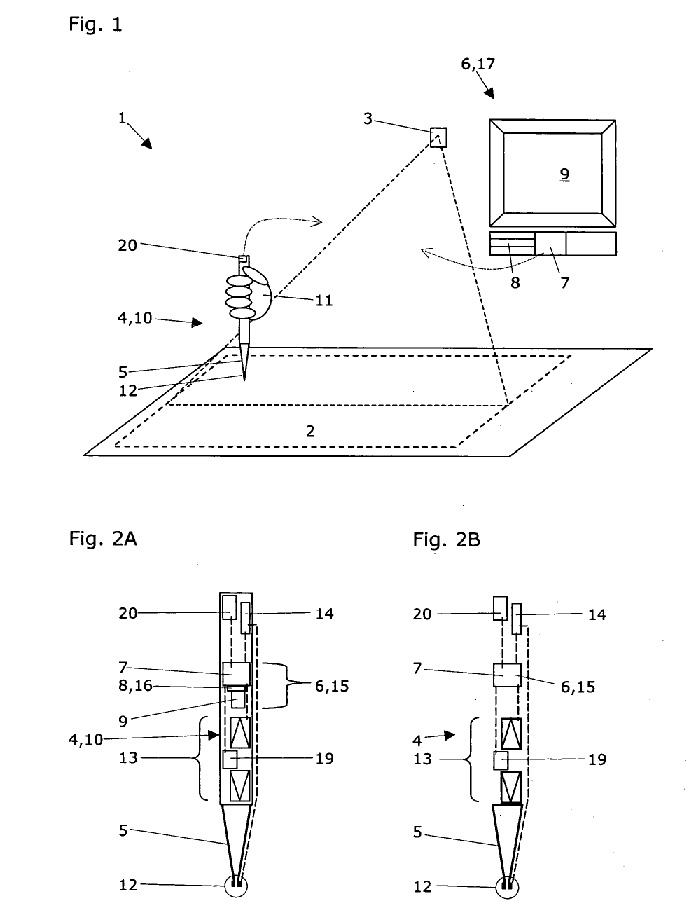

FIG. 1 shows a three dimensional scheme of a first embodiment of a sample transfer apparatus 1. This sample transfer apparatus 1 comprises a laboratory working area 2 with a first position retrieval system 3. Position retrieval systems that are applicable are known per se and usually are based on electromagnetic triangulation.

A person skilled in the art can—when knowing the present invention—select such a position retrieval system 3 from a group comprising graphic tablets (e.g., marketed by AIPTEK International GmbH, D-47877 Willich-Münchheide, Germany), an antenna array for the detection of radio frequency identification (RFID) tags, a 2-D or 3-D video detection system as marketed by Canesta Inc, San Jose, USA (see e.g., U.S. Pat. No. 6,710,770), an ultrasound based transmitter system integrated into a pen for a presentation board (see U.S. Pat. No. 5,866,856), or sensor arrays as known from U.S. Pat. No. 6,535,824 B1 and U.S. Pat. No. 6,668,230 B2; the disclosure of these four U.S. patents being incorporated herein by reference.

This sample transfer apparatus 1 further comprises a sample transfer tool 4 with an active tool piece 5. The appropriate transfer tool for transferring liquids may be a pipette or dispenser; the active tool piece 5 then preferably is the pipette or dispenser tip. If the active tool piece 5 is utilized in liquid handling, it may also comprise a pump system for a pipette or a dispenser. Other transfer tools for transferring solid state material like allergen discs may be a pair of tweezers, the active tool piece 5 then preferably is the pair of forceps tips. In this case, the active tool piece 5 may also comprise a spring system for opening the forceps tips. Still other transfer tools for transferring solid/liquid material like gel portions or bacterial cells may be a wire loop or a pin, the active tool piece 5 then is the loop or the tip of the pin.

This sample transfer apparatus 1 also comprises a data processing unit 6 comprising a calculator 7, a memory 8, and a display 9. It is not necessary that all these parts of the data processing unit be located together (see below), it is only necessary the sample transfer apparatus 1 is able to process data, to store data and to communicate with a user, preferably via a display (which can be an alpha numerical display or an LCD screen for example). Alternatively, the communication with the user or operator can be a display on an acoustic base, e.g., by voice-synthesized information or by different sound signals. Sound signals also could be combined with LED signals.

It is important that in the first embodiment of a sample transfer apparatus 1; the actual position of the active tool piece 5 is detectable by the first position retrieval system 3. This detection can be only in one of the X, Y, and Z directions of a 2-D or 3-D coordinate system. It is preferred, however, that the first position retrieval system 3 detects the actual position of the active tool piece 5 in two or three dimensions. This detection results in a position data set, which is then processed, stored and displayed with the different components of the data processing unit 6. In order to enable the first embodiment of a sample transfer apparatus 1 to acquire the necessary data, the active tool piece 5 of the sample transfer tool 4, the data processing unit, and the first position retrieval system 3 are in communication connection with each other.

In another approach, the system is set up to track the position and orientation of the hand held sample transfer tool 10, to which the active tool piece 5 is attached. This preferably is accomplished by two reference markers, e.g., one at the top and one at the bottom of the handle. With this alternative embodiment of a manual sample transfer apparatus 1, information about the X, Y, and Z orientation as well as inclination or tilt of the active tool piece 5, e.g., the pipette tip can be obtained.

The first embodiment of a sample transfer apparatus 1 is characterized in that the sample transfer tool 4 is a hand held sample transfer tool 10, which is manually carried by an operator 11. In case the sample transfer tool is a pipette, ergonomic pipettes are preferred; most preferred however, are pen-like pipettes as known from U.S. Pat. No. 4,369,665 or DE 196 16 300 A1; the disclosure of these two documents being incorporated herein by reference.

A basic equipment of a hand held pen-like pipette is a bidirectional pump system 13. Such a bidirectional pump system 13 can be accomplished as a bidirectional working, flap valve equipped membrane pump as known from the paper of Zengerle et al. “A Bidirectional Silicon Micropump”, 0-7803-2503-6© IEEE 1995, pages 19-24. Other variants comprise a combination of two inversely situated, unidirectional micropumps as known e.g., from DE 1989 02 368 or from EP 0 725 267 A2. The bidirectional pump system 13 can also be accomplished as a plunger system as known e.g., from U.S. Pat. No. 4,567,780. The disclosure of these documents is incorporated herein by reference.

An electronically monitored pipette preferably comprises a liquid level detection unit 14. As widely known in liquid handling, liquid level detection may be applied with many methods comprising e.g., capacitive, acoustic, electric, and pneumatic detecting the penetration of a liquid surface with the pipette tip.

The communication connection of the active tool piece 5 with the first position retrieval system 3 can be implemented as simply being visible by an optical position retrieval system or by being detectable by an RF emitter and an antenna for example. For this purpose, the active tool piece 5 of the sample transfer tool 4 comprises a reference unit 12 that is designed to interact with the first position retrieval system 3 of the laboratory working area 2 for the generation of the position data set. The reference unit may be implemented as e.g., a colored pipette or forceps tip, being visible by the first position retrieval system 3 when accomplished as optical detection system. Alternatively, the reference unit may be implemented as an emitter, as a radio frequency identification (RF ID) tag for example, that is emitting RF signals and that is detectable by the antenna array of an electromagnetic triangulation system.

As seen in FIG. 2A, the components calculator 7, memory 8, and display 9 of the data processing unit 6 can all be accomplished as an on-site processor 15 within the hand held pipette 10. The data processing unit 6 can also be a remote computer, like a PC. All intermediate solutions are possible too. A simple solution of recording, storing, processing and displaying relevant process data, comprising time, location, volume, and liquid class comprises the separation of the components of the data processing unit 6, so that only sensors are situated in the hand held sample transfer tool 10 and that all signals produced by these sensors are transmitted by wires or by a wireless communication system to a central data processing unit 6,15. However, it is preferred that every data processing unit 6,15,17 present in the sample transfer apparatus 1 according to the first embodiment is equipped with a memory 8. Transferable memories 16 that can be taken out from one data processing unit and that can be introduced into another data processing unit like a personal computer 17, are known e.g., as memory sticks or flash cards. Another preferred data transfer approach comprises a linking unit 20 that is integrated into the hand held sample transfer tool 10 and that is a part of a wireless data transfer solution like ZigBee™, Bluetooth™, and Wi-Fi™ as shown in table 1.

TABLE 1
Wireless Standard Comparison

| | ZigBee ™ | Bluetooth ™ | Wi-Fi ™ | GPRS/GSM |
|---|---|---|---|---|
| | 802.15.4 | 802.15.1 | 802.11b | 1XRTT/CDMA |
| Application Focus | Monitoring | Cable | Web, Video, | WAN, |
| | & Control | Replacement | Email | Voice/Data |
| System Resource | 4 KB-32 KB | 250 KB+ | 1 MB+ | 16 MB+ |
| Battery Life (days) | 100-1000+ | 1-7 | .1-5 | 1-7 |
| Nodes Per Network | 255/65K+ | 7 | 30 | 1,000 |
| Bandwidth (kbps) | 20-250 | 720 | 11,000+ | 64-128 |
| Range (meters) | 1-75+ | 1-10+ | 1-100 | 1,000+ |
| Key Attributes | Reliable, | Cost, | Speed, | Reach, |
| | Low Power, | Convenience | Flexibility | Quality |
| | Cost Effective | | | |

From the homepage of ZigBee ™ Alliance (Courtesy of Helicomm)

As ZigBee™ requires very low system resources and the same time provides for enormous battery life, and a reasonable operation range, it represents the most preferred wireless data transfer system for the present invention.

Most preferred solutions include hand held sample transfer tools 10 that are highly independent of other data processing units 6,17 and that are fully equipped with all necessary components 7,8,9 of a data processing unit 6 as seen in FIG. 2A. Independence from external electric power supplies is preferably achieved in that the pen-like pipette 10 further comprises an accumulator 18 for powering the pump system 13, the liquid level detector 14, and the on site processor 15. Such pen-like pipettes 10 preferably also comprise verifying means 19 for confirmation of pipetted volumes. Such verifying means 19 preferably are accomplished as a pressure or flow measuring device for monitoring and controlling the aspiration and dispensation process of the pipette. These verifying means 19 preferably are directly connected to the on-site processor 15.

FIG. 2B depicts in a very schematic layout the basic function elements of the hand held sample transfer tool 10 embodied as a pipette. In order to transfer an assay protocol developed with an operator carried, hand held sample transfer 10 tool to a robotic sample processor 61 of a laboratory workstation 51, the robotic sample processor 61 has to be equipped with the characterizing elements of the pipette. The most important of these elements are deemed to be the bidirectional pump system 13 and the pipette tip. For ease of function and handling, the robotic sample processor 61 can additionally be equipped with an on-site processor 15, verifying means 19, and liquid level detection unit 14. Provided that the on-site sample processor 15 is connected with the computer 56 of the laboratory workstation 51, data transfer can be accomplished via the linking unit 20 so that a memory and a display is not required on the pipette of the robotic sample processor 61.

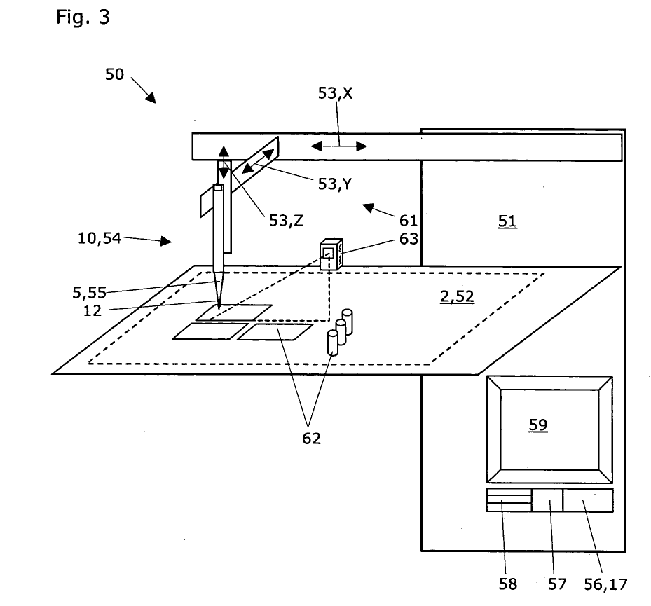

FIG. 3 shows a three dimensional scheme of a second embodiment of a sample transfer apparatus 50, which is implemented as a laboratory work station 51 in that the hand held sample transfer tool 10 of FIG. 2 is attached to the robotic sample processor 61. This sample transfer apparatus 50 comprises a laboratory workstation 51 with a worktable 52 and a second position retrieval system 53. The sample transfer apparatus 50 also comprises a robotic sample processor 61 with a sample transfer tool 54 and an active tool piece 55 as well as a data processing unit 56 comprising a calculator 57, a memory 58, and a display 59. Here, the actual position of the active tool piece 55 is detectable by the second position retrieval system 53 in at least one of the X, Y, and Z directions of a 2-D or 3-D coordinate system. The actual position of the active tool piece 55 represented as a position data set to be processed, stored and displayed with the data processing unit 56. Again, the active tool piece 55 of the sample transfer tool 54, the data processing unit 56, and the second position retrieval system 53 are in communication connection with each other. The second embodiment of a sample transfer apparatus 50 is characterized in that the sample transfer tool 54 is a hand held sample transfer tool 10. It is the same (or an identical) hand held sample transfer tool 10 that had been used for the manual establishing of an assay protocol as shown in FIG. 1. The hand held sample transfer tool 10 is attached to the robotic sample processor 61 of the laboratory workstation 52 and the second position retrieval system 53 is implemented as the drives for X, Y, and Z movements of the robotic sample processor 61 for the generation of the position data set. Most preferred is a hand held sample transfer tool 10 that is a pen-like pipette and that is attached to one of the robotic sample processors 61 of the laboratory workstation 52.

As an important feature, the hand held sample transfer tool 10 accomplished as a hand held pipette comprises a bidirectional pump system 13. In order to verify the penetration of a liquid, a certain volume is to be aspirated into the sample transfer tool 10; the pen-like pipette preferably comprises a liquid level detection unit 14. It is also preferred that the pen-like pipette 10 comprises verifying means 19 for confirmation of pipetted volumes, the verifying means 19 being accomplished as a pressure or flow measuring device and being connected with the data processing unit 56. The pen-like pipette 10 further comprises a linking unit 20 for connecting the bidirectional pump system 13 and the liquid level detection unit 14 with the data processing unit 56. Thus, automatic pipetting can be performed with the laboratory workstation 51. The connection of the linking unit 20 and the data processing unit 56 is preferably based on wireless data transfer.

Traditionally, samples and other liquids or solid-state materials are arranged in labware containers on the laboratory working area 2 or on a worktable 52 of a laboratory workstation 51. Typical labware 62 comprises containers such as microplates or microtitre plates, sample tubes (e.g., for blood samples), troughs (e.g., for solvents or buffers), waste collecting containers and so on. A laboratory workstation 51 according to the second embodiment of the present invention preferably comprises fixation means 61 for holding labware 62 in pre-defined positions on the worktable 52. In addition, such a laboratory workstation 51 preferably further comprises identifying means 63 for the identification of labware 62, samples and modules such as racks, magnet separators and readers, present on the worktable 52. This identification means 63 include bar code readers, laser scanners, and video cameras. Such identification means 63 can be combined with temperature sensors, balances and transportation units.

At least two sample transfer instruments 1 according to the first embodiment (see FIG. 1) are preferably combined with each other in order to create a multi-workplace sample transfer system. Utilizing such a sample transfer system enables to manually establish assay protocols with a hand held sample transfer tool 10 and to manually apply these assay protocols while controlling and monitoring the manual application in a central data processing unit 6. Detailed assay protocols may be printed for quality control and customer need purposes.

Even more preferred is the combination of a sample transfer apparatus 1 according to the first embodiment (see FIG. 1) with a sample transfer apparatus 51 of the second embodiment (see FIG. 3) in order to create a sample transfer system. Utilizing such a sample transfer system enables manual establishing of assay protocols with a hand held sample transfer tool 10 and robotized application of the established assay protocols on a worktable 52 of a laboratory workstation 51 equipped with robotic sample processor 61.

There exist two approaches of the second embodiment of the present invention which complement one another:
As already described, a first approach attaches the same or an identical hand held sample transfer tool 10 (as has been utilized for the manual establishment of the assay protocol) to the robotic sample processor 61 (see FIG. 3). The assay protocol then is carried out automatically with the same or identical sample transfer tool 10.
In a second approach, a sample transfer apparatus 50 as utilized for the first approach is equipped with a sample transfer tool 54. In case of a pipette, this sample transfer tool comprises the bidirectional pump system 13 and the liquid level detection unit 14 of the hand held sample transfer tool 10 and is implemented into a robotic sample processor 61 of the laboratory workstation 52. Of course, identical pipette tips, disposable single pipette tips or disposable multiple pipette tips are utilized. Such a sample transfer apparatus 50 not necessarily comprises identification means 63, since the robotic sample processor 61 already knows where it is placing the sample transfer tool. However, the addition of an identification means 63 is preferred.

When combining both embodiments of the present invention (applying the first or second approach of the second embodiment), the following method of transferring an assay protocol developed with an operator carried, hand held sample transfer tool 10 to a robotic sample processor 61 of a laboratory workstation 51 can be carried out:
(a) Execution of an assay protocol with a sample transfer apparatus 1, comprising a laboratory working area 2 with a first position retrieval system 3; a hand held sample transfer tool 10 with an active tool piece 5, which is manually carried by an operator 11; and a data processing unit 6 comprising a calculator 7, a memory 8, and a display 9; the data processing unit 6, and the first position retrieval system 3 being in communication connection with each other;
(b) Detection of the actual position of the active tool piece 5 at every assay protocol step with the first position retrieval system 3 of the laboratory working area 2 in at least one of the X, Y, and Z directions of a 2-D or 3-D coordinate system and storing these data as a position data set;
(c) Detection of all individual protocol parameters at every assay protocol step as a parameter data set and adding this parameter data set to the position data set of step (b), thereby creating a position/parameter data set;
(d) Processing of all position/parameter data sets of the assay protocol as a virtual protocol and storing this virtual assay protocol with the data processing unit 6; and
(d) Loading of the virtual assay protocol into the data processing unit 56 of the laboratory workstation 51 and attaching the hand held sample transfer tool 10 to the robotic sample processor 61 of the laboratory workstation 51.

According to the first approach of the second embodiment of the present invention, attaching the hand held sample transfer tool 10 to the robotic sample processor 61 of the laboratory workstation 51 is preferably executed by clipping the transfer tool 10 to a Z-axis rod of the robotic sample processor 61.

According to the second approach of the second embodiment of the present invention, attaching the hand held sample transfer tool 10 to the robotic sample processor 61 of the laboratory workstation 51 is preferably executed by the equipping of the robotic sample processor 61 with the basic function elements of the transfer tool 10.

With a laboratory workstation modified according to one of these approaches, the virtual assay protocol can automatically be executed with the robotic sample processor 61 of the laboratory workstation 51. In addition, the virtual assay protocol may be modified prior to automatically executing with the robotic sample processor 61 of the laboratory workstation 51. Such modification can comprise up-scaling and rescheduling procedures.

In some places of the present description, there was only mentioned a pipette. Preferably, such a pipette is a pen-like pipette comprising a bidirectional pump system 13 and more preferably a liquid level detection unit 14 too. Nevertheless, any other the hand held sample transfer tool 10 might be selected for a similar purpose of transferring a liquid, semi solid or solid sample from one location to another. Such alternative hand held sample transfer tools 10 being selected from a group comprising a dispenser, a pipette, a pair of tweezers, a loop, and a needle. For a dispenser, a pump working only in one direction is sufficient.

As described already, the first position retrieval system 3 is preferably selected from a group comprising an electromagnetic triangulation and an optical detection system, and loading the virtual assay protocol into the data processing unit 56 of the laboratory workstation 51 preferably is carried out by wireless data transfer or by physical transfer of a memory stick containing the virtual assay protocol.

What is claimed:

1. Sample transfer apparatus (1), comprising a laboratory working area (2) with a first position retrieval system (3), a sample transfer tool (4) with an active tool piece (5), and a data processing unit (6) comprising a calculator (7), a memory (8), and a display (9); the actual position of the active tool piece (5) being detectable by the first position retrieval system (3) in at least one of the X, Y, and Z directions of a 2-D or 3-D coordinate system as a position data set to be processed, stored and displayed with the data processing unit (6); the active tool piece (5) of the sample transfer tool (4), the data processing unit (6), and the first position retrieval system (3) being in communication connection with each other, wherein the sample transfer tool (4) is a hand held sample transfer tool (10), which is manually carried by an operator (11); the active tool piece (5) of the sample transfer tool (4) comprising a reference unit (12) that is designed to interact with the first position retrieval system (3) of the laboratory working area (2) for the generation of the position data set.

2. Sample transfer apparatus (50), comprising a laboratory workstation (51) with a worktable (52), a second position retrieval system (53), a robotic sample processor (61) with a sample transfer tool (54) and an active tool piece (55), and a data processing unit (56) comprising a calculator (57), a memory (58), and a display (59); the actual position of the active tool piece (55) being detectable by the second position retrieval system (53) in at least one of the X, Y, and Z directions of a 2-D or 3-D coordinate system as a position data set to be processed, stored and displayed with the data processing unit (56); the active tool piece (55) of the sample transfer tool (54), the data processing unit (56), and the second position retrieval system (53) being in communication connection with each other, wherein the sample transfer tool (54) is a hand held sample transfer tool (10), which is attached to the robotic sample processor (61) of the laboratory workstation (52); the second position retrieval system (53) being implemented as the drives for X, Y, and Z movements of the robotic sample processor (61) for the generation of the position data set.

3. The sample transfer apparatus (1,50) of claim 1, wherein the hand held sample transfer tool (10) is accomplished as one selected from a group comprising a dispenser, a pipette, a pair of tweezers, a loop, and a needle.

4. The sample transfer apparatus (1) of claim 1, wherein the first position retrieval system (3) is accomplished by electromagnetic triangulation, the reference unit (12) being implemented into the active tool piece (5) of the sample transfer tool (4) as an emitter detectable by the electromagnetic triangulation.

5. The sample transfer apparatus (1) of claim 1, wherein the first position retrieval system (3) is accomplished as an antenna array for receiving radio frequency (RF) signals, the reference unit (12) being implemented into the active tool piece (5) of the sample transfer tool (4) as a radio frequency identification (RF ID) tag, emitting RF signals detectable by the antenna array.

6. The sample transfer apparatus (1) of claim 1, wherein the first position retrieval system (3) is accomplished as optical detection system, the reference unit (12) being implemented into the sample transfer tool (4) as the tip of the active tool piece (5).

7. The sample transfer apparatus (1) of claim 1, wherein the hand held sample transfer tool (10) is a pen-like pipette comprising a bidirectional pump system (13).

8. The sample transfer apparatus (1) of claim 7, wherein the pen-like pipette comprises a liquid level detection unit (14).

9. The sample transfer apparatus (1) of claim 7, wherein the pen-like pipette (10) further comprises an on site processor (15) that is capable to record, store, and display relevant process data comprising, time, location, volume, and liquid class.

10. The sample transfer apparatus (1) of claim 9, wherein the on site processor (15) comprises a removable memory stick (16) that is capable to be inserted into the data processing unit (6) or into a personal computer (17).

11. The sample transfer apparatus (1) of claim 7, wherein the pen-like pipette (10) further comprises an accumulator (18) for powering the pump system (13), the liquid level detector (14), the on site processor (15), and—if present—a linking unit (20).

12. The sample transfer apparatus (1) of claim 9, wherein the pen-like pipette (10) further comprises verifying means (19) for confirmation of pipetted volumes, the verifying means (19) being accomplished as a pressure or flow measuring device and being connected to the on site processor (15).

13. The sample transfer apparatus (1) of claim 7, wherein the pen-like pipette (10) further comprises a linking unit (20) for connecting the bidirectional pump system (13) and the liquid level detection unit (14) with the data processing unit (6).

14. The sample transfer apparatus (1) of claim 7, wherein the pen-like pipette (10) further comprises a linking unit (20) for connecting the bidirectional pump system (13), the liquid level detection unit (14), and the on site processor (15) with the data processing unit (6).

15. The sample transfer apparatus (1) of claim 12, wherein the connection of the linking unit (20) and the data processing unit (6) is based on wireless data transfer.

16. A sample transfer system, which comprises at least two sample transfer apparatuses (1) according to claim 1.

17. A sample transfer system, which comprises at least one sample transfer apparatus (1) according to claim 1 and at least one sample transfer apparatus (1) according to claim 2.

18. The sample transfer apparatus (50) of claim 2, wherein the hand held sample transfer tool (10) is a pen-like pipette attached to a robotic sample processor (61) of the laboratory workstation (52) and comprises a bidirectional pump system (13).

19. The sample transfer apparatus (50) of claim 18, wherein the pen-like pipette comprises a liquid level detection unit (14).

20. The sample transfer apparatus (50) of claim 18, wherein the pen-like pipette (10) further comprises verifying means (19) for confirmation of pipetted volumes, the verifying means (19) being accomplished as a pressure or flow measuring device and being connected with the data processing unit (56).

21. The sample transfer apparatus (50) of claim 18, wherein the pen-like pipette (10) further comprises a linking unit (20) for connecting the bidirectional pump system (13) and the liquid level detection unit (14) with the data processing unit (56).

22. The sample transfer apparatus (50) of claim 20, wherein the connection of the linking unit (20) and the data processing unit (56) is based on wireless data transfer.

23. The sample transfer apparatus (50) of claim 18, wherein the workstation (51) further comprises fixation means (61) for holding labware (62) in pre-defined positions on the worktable (52).

24. The sample transfer apparatus (50) of claim 17, wherein the workstation (51) also comprises identifying means (63) for the identification of labware (62) present on the worktable (52).

25. Sample transfer apparatus (50), comprising a laboratory workstation (51) with a worktable (52), a second position retrieval system (53), a sample transfer tool (54) with an active tool piece (55), and a data processing unit (56) comprising a calculator (57), a memory (58), and a display (59); the actual position of the active tool piece (55) being detectable by the second position retrieval system (53) in at least one of the X, Y, and Z directions of a 2-D or 3-D coordinate system as a position data set to be processed, stored and displayed with the data processing unit (56); the active tool piece (55) of the sample transfer tool (54), the data processing unit (56), and the second position retrieval system (53) being in communication connection with each other, wherein the sample transfer tool (54) is a pipette that comprises the bi-directional pump system (13) and the liquid level detection unit (14) of the hand held sample transfer tool (10) of claim 7; the bidirectional pump system (13) and the liquid level detection unit (14) being implemented into a robotic sample processor (61) of the laboratory workstation (52); the second position retrieval system (53) being implemented as the drives for X, Y, and Z move-ments of the robotic sample processor (61) for the generation of the position data set.

26. A sample transfer system, which comprises at least one sample transfer apparatus (1) according to claim 1.

27. Method of transferring an assay protocol developed with an operator carried, hand held sample transfer tool to a robotic sample processor (61) of a laboratory workstation (51); the laboratory workstation (51) also comprising a worktable (52); a data processing unit (56) with a calculator (57), a memory (58), and a display (59); a second position retrieval system (53) that is implemented as drives for X, Y, and Z movements of the robotic sample processor (61), which in turn is in communication connection with the data processing unit (56) and the second position retrieval system (53), wherein the method comprises the steps of:
(a) executing an assay protocol with a sample transfer apparatus (1), comprising a laboratory working area (2) with a first position retrieval system (3); a hand held sample transfer tool (10) with an active tool piece (5), which is manually carried by an operator (11); and a data processing unit (6) comprising a calculator (7), a memory (8), and a display (9); the data processing unit (6), and the first position retrieval system (3) being in communication connection with each other;
(b) detecting the actual position of the active tool piece (5) at every assay protocol step with the first position retrieval system (3) of the laboratory working area (2) in at least one of the X, Y, and Z directions of a 2-D or 3-D coordinate system and storing these data as a position data set;
(c) detecting all individual protocol parameters at every assay protocol step as a parameter data set and adding this parameter data set to the position data set of step (b), thereby creating a position/parameter data set;
(d) processing all position/parameter data sets of the assay protocol as a virtual assay protocol and storing this virtual assay protocol with the data processing unit (6); and
(e) loading the virtual assay protocol into the data processing unit (56) of the laboratory workstation (51) and attaching the hand held sample transfer tool (10) to the robotic sample processor (61) of the laboratory workstation (51).

28. The method of claim 27, wherein the virtual assay protocol is automatically executed with the robotic sample processor (61) of the laboratory workstation (51).

29. The method of claim 27, wherein the virtual assay protocol is modified prior to automatically executing with the robotic sample processor (61) of the laboratory workstation (51).

30. The method of claim 27, wherein the hand held sample transfer tool (10) is selected from a group comprising a dispenser, a pipette, a pair of tweezers, a loop, and a needle.

31. The method of claim 27, wherein attaching the hand held sample transfer tool (10) to the robotic sample processor (61) of the laboratory workstation (51) is executed by clipping the transfer tool (10) to a Z-axis rod of the robotic sample processor (61) or by the equipping the robotic sample processor (61) with the basic function elements of the transfer tool (10).

32. The method of claim 26, wherein the hand held sample transfer tool (10) is a pen-like pipette comprising a bidirectional pump system (13).

33. The method of claim 32, wherein the pen-like pipette comprises a liquid level detection unit (14).

34. The method of claim 27, wherein the first position retrieval system (3) is selected from a group comprising an electromagnetic triangulation and an optical detection system.

35. The method of claim 26, wherein loading the virtual assay protocol into the data processing unit (56) of the laboratory workstation (51) is carried out by wireless data transfer or by physical transfer of a memory stick containing the virtual assay protocol.
